(19) United States
(12) Patent Application Publication
(10) Pub. No.: US 2013/0173868 A1
(43) Pub. Date: Jul. 4, 2013

(54) Generation of Activation List for Memory Translation and Memory Access Protection in Industrial Ethernet Standard

(71) Applicants: TEXAS INSTRUMENTS DEUTSCHLAND GmBH, Freising (DE); TEXAS INSTRUMENTS INCORPORATED, Dallas, TX (US)

(72) Inventors: Thomas Leyrer, Geisenhausen (DE); Pratheesh Gangadhar TK, Bangalore (IN); Shrey Bhatia, Freising (DE)

(73) Assignees: TEXAS INSTRUMENTS INCORPORATED, Dallas, TX (US); TEXAS INSTRUMENTS DEUTSCHLAND GmBH, Freising (DE)

(21) Appl. No.: 13/726,769

(22) Filed: Dec. 26, 2012

(30) Foreign Application Priority Data
Dec. 29, 2011 (EP) 11196066.2

(51) Int. Cl. G06F 12/14

(52) U.S. Cl. CPC G06F 12/1483
USPC 711/152

(57) ABSTRACT

The invention relates to an EtherCAT fieldbus system, a master and a slave for the system and a method. The slave is configured to be coupled to the EtherCAT fieldbus. A first configurable memory of the slave stores a first activation list indicating for consecutive bytes of data of an EtherCAT datagram a corresponding fieldbus memory management information or synchronization management information.

### CLAIM OF PRIORITY

This application claims priority under 35 U.S.C. 119(a) to EPO Patent Application No. 11196066.2 filed Dec. 29, 2011.

### TECHNICAL FIELD OF THE INVENTION

The technical field of this invention is a system, an electronic device and methods for the industrial Ethernet standard for Control Automation Technology.

### BACKGROUND OF THE INVENTION

Ethernet for Control Automation Technology (EtherCAT) is an open high performance Ethernet-based fieldbus system. EtherCAT applies Ethernet to automation applications. These automation applications require short data update times with low communication jitter and low hardware costs. Typical automation networks have a short data length per node, typically less than the minimum payload of an Ethernet frame. Thus using one frame per node per cycle leads to low bandwidth utilization and poor overall network performance.

EtherCAT takes an approach called processing on-the-fly. With EtherCAT the Ethernet packet or frame is no longer received, interpreted and copied at every node. EtherCAT slave devices read data addressed to them while the telegram passes through the slave device. Input data are inserted while the telegram passes through. Frames are delayed by only a fraction of a microsecond in each node.

Many nodes, which may include the entire network, can be addressed with just one frame. The EtherCAT protocol is optimized for process data and is transported directly within the standard IEEE 802.3 Ethernet. The EtherCAT protocol may consist of several sub-datagrams. Each sub-datagram serves a particular memory area of the logical process images up to 4 GB. The data sequence in the EtherCAT protocol is independent of the physical order of the nodes in the network. Addressing can be in any order. Broadcast, multicast and communication between slaves are possible.

An EtherCAT fieldbus system typically contains a large number of EtherCAT slaves (nodes). These slaves process the incoming telegrams directly. Slaves may extract relevant user data or may insert data. Slaves transfer the telegram to the next EtherCAT slave. Ethernet deals separately with transfers in separate directions (Tx and Rx lines) and operates in full duplex mode.

Each slave contains several hard-wired fieldbus memory management units (FMMUs) which perform memory mapping between the logical addresses of the system and the physical (or local) addresses of the slave. The FMMU converts a logical address into a physical address. The FMMU is integrated in the EtherCAT slave Application Specific Integrated Circuit (ASIC) and enables individual address mapping for each device.

Unlike processor-internal memory management units (MMUs) that map complete memory pages in the range of 4 kB, the FMMU supports bit-wise mapping. This enables single bits to be inserted individually anywhere within a logical address space. If an EtherCAT command writes to a certain memory area the appropriate slave device inserts data at the right place within the data area. All other slaves may also detect an address match within their own FMMU and insert their data. Many slave devices can be addressed simultaneously with a single EtherCAT command.

Since a FMMU is present in each device and is configured individually, the EtherCAT master can assemble complete process images during the initialization phase and later exchange them via a single EtherCAT command.

Additional mapping is not required by the master. Process data can be assigned directly to the different control tasks (PLC, NC, etc.). Each task may create its own process image and exchange this image within its own timeframe. The physical order of the EtherCAT devices is independent and is only relevant during the first initialization phase.

While the telegrams are already passed on delayed by only a few bits, the slave recognizes relevant commands and executes them accordingly. An advantage of existing EtherCAT systems is that processing takes place within the hardware and is therefore independent of the response times of any provided microprocessors.

Each EtherCAT slave device includes in addition to the FMMUs several synchronization management (SM) units (SYNC managers). Each synchronization management unit manages memory access to a specific part (channel) of the local shared memory of the slave. This prevents conflicts if simultaneous access to the same physical address is requested. The synchronization management units are also hard-wired in implementations using ASICs or Field Programmable Gate Arrays (FPGAs).

The primary disadvantage of the conventional hard-wired solutions is that all FMMUs have to check whether incoming data are associated with the specific logical address or logical address range of the corresponding save device for all incoming data in logical addressing mode,. The relevant FMMUs output the corresponding physical address for a received logical address. This physical address has to be passed to all synchronization managing units to check whether the respective synchronization management unit is assigned to this physical address. With an increasing number of FMMUs (up to 16 are allowed by the present standard) and an increasing number of SM units (up to 16 are allowed by the present standard), this procedure becomes too time consuming or requires a very large integrated circuit area if implemented in a parallel hardware.

### SUMMARY OF THE INVENTION

It is an object of the invention, to provide an EtherCAT system, a master, a slave and a method which allow the system configuration to be adapted without increasing the length of time or the integrated circuit area needed to read from and write to the local shared memory in logical addressing mode.

In one aspect of the invention a EtherCAT slave device is configured to be coupled to an Ethernet for Control Automation Technology (EtherCAT) bus. The slave device comprises a first configurable memory storing a first activation list indicating for consecutive bytes (such as each consecutive byte) of data of an EtherCAT datagram corresponding fieldbus memory management (FMM) information or synchronization management (SM) information.

In a first embodiment of the invention, the first activation list can be the FMM activation list, which is a list of FMM information. This first embodiment permits the assignment of the field management information to incoming data in the logical addressing mode to no longer be hard-wired. The first activation list directly indicates the fieldbus memory management information. This could be, for example, a field memory management identifier assigning a physical address to a logical address for each incoming data byte. The first activation list may then include a pointer to a storage location, such as a register, storing the correspondence between logical addresses and physical addresses. The first activation list may include the respective physical address for a logical address of data included in an EtherCAT datagram in an Ethernet data frame propagating on the EtherCAT bus. The fieldbus memory management information can comprise an indicator of a fieldbus memory management configuration, such as the configuration of the conventionally used FMMU, which is assigned to a byte of a data.

The fieldbus memory management information may comprise the relation between a logical address of the fieldbus system and a physical address of the slave device.

The first activation list is advantageously a sorted list of fieldbus memory management information in accordance with the sequence of bytes in the data portion of a datagram. The entries in the first activation list are sorted in ascending order of the logical addresses of the data in the EtherCAT datagram. This provides maximum processing speed and very low latency.

The first activation list can be programmed during initialization of the fieldbus system. The EtherCAT master may set up a full image of the distributed shared memory in the slaves in and send the respective field memory management configuration to the slaves during start-up of the system.

For the consecutive bytes or each consecutive byte of data of the EtherCAT datagram, the activation list may contain corresponding fieldbus memory management information, for example a pointer to another memory location in which stored the physical address corresponding to the logical address of the received data byte.

In a second embodiment, the first activation list may directly contain the corresponding physical address. The EtherCAT slave may be configured to sort the field management information in ascending order of logical addresses and to store the sorted list as the first activation list.

The physical address received through the first activation list can then be used to perform synchronization management. The slave may further include a second portion of configurable memory storing a second activation list indicating for each physical address that is retrieved through the first activation list synchronization management information (SM information). The second activation list is also referred to as SM activation list.

Synchronization management (SYNC management) is necessary to organize and restrict access to the same physical address of the shared memory in the slave. The physical address is passed to a second activation list from which further memory access information is received. The physical addresses can either be received from the bus in physical addressing mode or from the previously described fieldbus memory management operation using the first activation list.

The second activation list is similar to the first activation list. The second activation list can then be organized in ascending order of physical addresses corresponding to the incoming data of the EtherCAT datagram having respective increasing logical addresses or physical addresses. The second activation list is advantageously a sorted list of synchronization management information in the order of incoming data bytes.

The second activation list may be programmed during initialization of the fieldbus system. The EtherCAT master sets up a full image of the distributed shared memory in the slaves in the system and sends the respective SM configuration to the slaves during start-up of the system.

The EtherCAT slave may be configured to sort the synchronization management information in ascending order of physical addresses and to store the sorted list as the second activation list.

According to another aspect of the invention, only the second activation list may be used in physical addressing mode. The second activation list may be configured as previously described. The physical addresses are not received from the first activation list but from an EtherCAT datagram on the bus.

FMM information and SM information may relate to local memory access. The information relating to the bit shifts for bit-wise access to the local memory is advantageously FMM information.

The invention also relates to a master configured to be coupled to an Ethernet for Control Automation Technology (EtherCAT) bus. The master can retrieve information from the EtherCAT slaves in order to determine the respective FMM and SM configuration of each slave. The master may then send the respective FMM and SM configuration to each slave. The first activation list and the second activation list are set up in the slaves by sorting the FMM configuration in ascending order of logical addresses and the SM configuration in ascending order of physical addresses.

The invention also relates to a fieldbus system which comprises at least one master and a slave. The master and the at least one slave are coupled through the Ethernet for Control Automation Technology (EtherCAT) bus.

The invention also relates to a method of operating a fieldbus system. The fieldbus system comprises a master and at least one slave coupled through an Ethernet for Control Automation Technology (EtherCAT) bus.

A first portion of configurable memory of the slave stores a first activation list indicating for (each) consecutive byte(s) of data of an EtherCAT datagram corresponding fieldbus memory management information or synchronization management information. The first activation list may indicate the FMM information. A second portion of configurable memory of the slave may store a second activation list indicating synchronization management information for the FMM information, such as the physical address, retrieved from the first activation list.

The available FMM information can be sorted in ascending order of logical addresses.

The available SM information can be sorted in ascending order of physical addresses.

### BRIEF DESCRIPTION OF THE DRAWINGS

These and other aspects of this invention are illustrated in the drawings, in which:

FIG. 1 illustrates a simplified block diagram of an EtherCAT fieldbus system to which the present invention applies;

FIG. 2 illustrates a simplified block diagram of an EtherCAT slave device to which the present invention applies;

FIG. 3 is a simplified flow chart illustrating aspects of the invention;

FIG. 4 illustrates a more detailed block diagram of an EtherCAT slave device according to an embodiment of the invention;

FIG. 5 illustrates a standard Ethernet data frame including an EtherCAT datagram; and

FIG. 6 illustrates the composition of an activation list according to an embodiment of the invention.

### DETAILED DESCRIPTION OF PREFERRED EMBODIMENTS

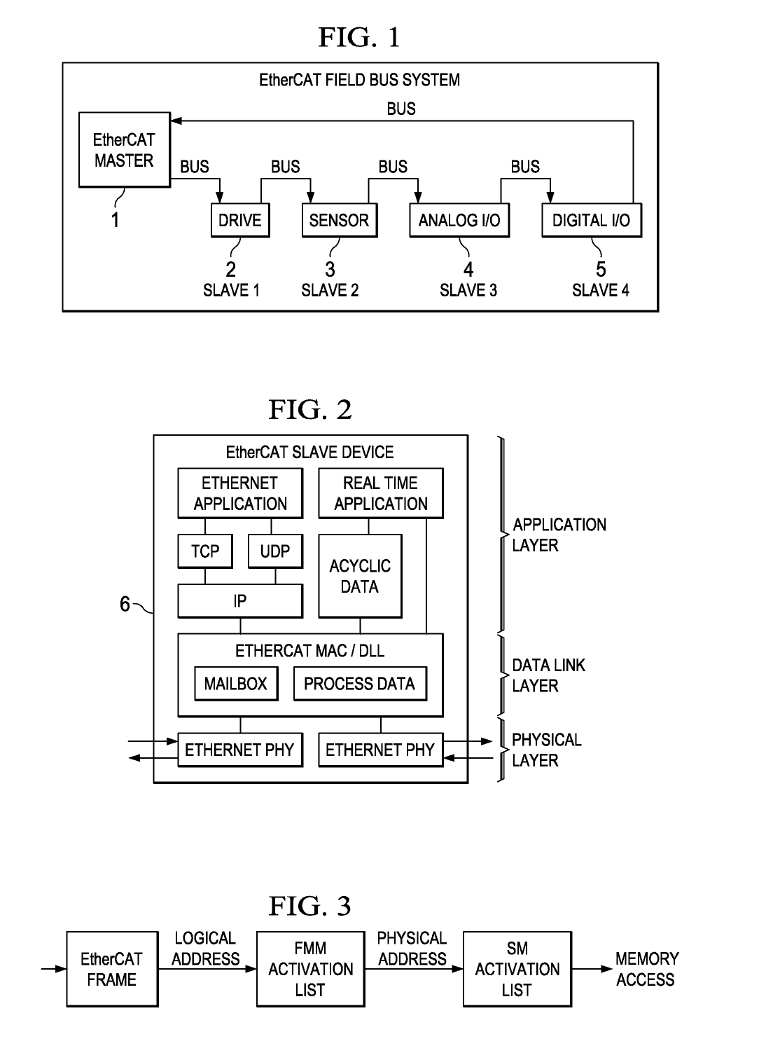

FIG. 1 illustrates a simplified block diagram of an EtherCAT fieldbus system according to aspects of the invention. An EtherCAT master device 101 is coupled with several EtherCAT slave devices through an EtherCAT bus. The EtherCAT slave devices 102, 103, 104 and 105 can be drivers, sensors and/or analogue input/output devices.

FIG. 2 shows a simplified block diagram of an EtherCAT slave device 106 to which the present invention applies. The EtherCAT slave device, also referred to as EtherCAT node, has three stages. These are physical layer 210, data link layer 220 and application layer 230. Physical layer 210 illustrated in FIG. 2 includes two Ethernet PHYs 211 and 213. Physical layer 210 may be implemented using standards as for example 100 BASE-TX copper, 100 BASE-FX optical fiber or E-bus based on LVDS signaling. Data link layer 220 includes EtherCAT MAC/DLL 221 having mailbox 222 and process data 223. Data link layer 220 is usually implemented with a specialized ASIC or FPGA according to the EtherCAT standard specification. The EtherCAT MAC or data link layer (DLL) 221 takes care of application-specific behavior and standard TCP/IP and UDP/IP stacks to support Ethernet-based device profiles.

Conventionally, the EtherCAT slave device may be implemented in hardware or a combination of hardware and software running in an embedded CPU depending on the complexity of the device.

The EtherCAT slave device according to the present invention mainly uses a software (firmware) approach in combination with an embedded microprocessor EtherCAT Slave Controller (ESC). The microprocessor integrates a programmable real-time unit (PRU) subsystem, which supports very low level interaction with the media independent interfaces (MII). This capability enables the PRU subsystem to implement specialized communication protocols such as EtherCAT. The entire EtherCAT MAC layer is encapsulated in the PRU subsystem through firmware. The PRUs process EtherCAT telegrams on-the-fly, parse them, decode the address and execute the EtherCAT commands. Interrupts are used for any communication required with the processor where the EtherCAT stack and the industrial application run. The PRU subsystem also performs the frame forwarding in reverse direction. In accordance with aspects of the invention, the fieldbus memory management and synchronization management operations that have previously been implemented with hard-wired FMMUs and SYNC managers are now implemented using programmable activation lists. Since the PRU subsystem implements all EtherCAT functionality, the processor can be utilized for complex applications or a lower speed variant can be used for simpler and cost-constrained applications.

FIG. 3 shows a simplified diagram illustrating the process flow during operation according to an embodiment of the invention. If an EtherCAT frame 311 arrives on the bus and contains data in logical addressing mode, the logical addresses are passed to FMM activation list 312. FMM activation list 312 provides the corresponding physical addresses, which are passed to SM activation list 313. SM activation list 313 then provides all necessary information to grant or deny access to the respective part of the shared memory.

In physical addressing mode, the physical addresses may be sent over the bus. In this situation the physical addresses can directly be applied to SM activation list 313. The physical addresses are then not received from FMM activation list 312.

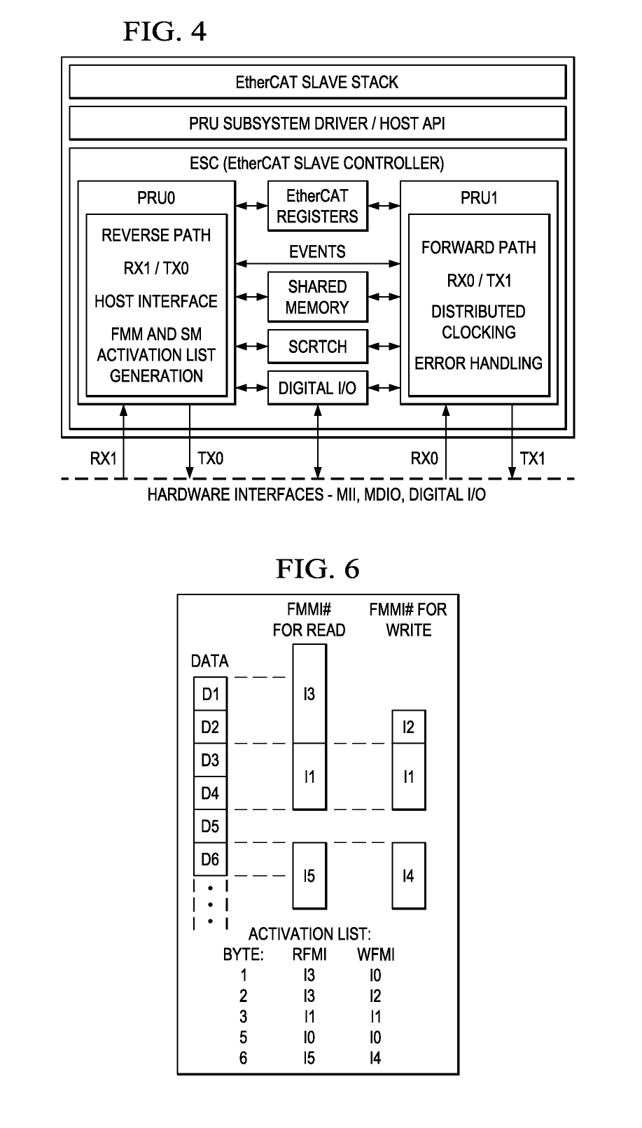

FIG. 4 shows a more detailed simplified block diagram of the EtherCAT slave device 106 according to aspects of the invention. The EtherCAT slave controller (ESC) 430 (PRU subsystem driver and host API 420) includes two programmable real-time units PRU0 431 and PRU1 433. PRU0 431 includes reverse path 432 including host interfaces and performs memory access synchronization management (SYNC management (SM)) and fieldbus memory management (FMM). PRU0 431 detects changes in the FMM and SM settings, generates the respective activation lists and sorts the activation lists. As long as the generation and the sorting is not complete, PRU0 431 signals to PRU1 433 that the working counter (WKC) cannot be incremented for the next EtherCAT frames until the activation lists are ready to use. PRU1 433 includes forward path 434 that performs distributed clocking and error handling. PRU1 431 processes EtherCAT frames in forward direction where it interprets commands, searches for a FMM activation list index on logical commands, searches for a SM activation list index on physical address and executes memory access with the given settings (SM information and FMM information determined through the activation lists).

The activation lists are stored in stage SCRTCH 437 which comprises register banks that can be accessed and swapped by both PRUs 431 and 433. The FMM and SM settings reside in these shared EtherCAT registers.

The media access control (MAC) data communication protocol sublayer is a sublayer of the data link layer (DLL) specified in the seven layer OSE model. It provides addressing and general access control mechanisms that make it possible for several terminals or network nodes to communicate within a multiple access network that incorporates a shared medium, as for example Ethernet.

The overall sequence of operations according to this embodiment of the invention includes memory access from the EtherCAT master to the EtherCAT slave controller ESC 430. The EtherCAT master configures the FMM registers and SM registers during the start-up phase of the system.

The EtherCAT master typically retrieves the EtherCAT slave controller ESC 430 configuration through an EtherCAT slave information (ESI) file or through register access to EtherCAT slave information data in ESC 430. The ESC 430 configuration comprises the settings for FMM (fieldbus memory management) and SM (synchronization management). Based on this information, the EtherCAT master writes new settings into the FMM registers and SM registers. The EtherCAT master is also allowed to change this configuration later during the normal operation phase (after the start-up phase).

In a subsequent step, ESC 430 generates the activation lists for the FMM and SM operations. ESC 430 also detects when the EtherCAT master changes register settings for FMM and SM operations. After any change ESC 430 generates new sorted activation lists for FMM operation and SM operations using bubble sort.

The FMM and SM activation lists reside in dedicated register banks SCRTCH 437 which are shared between PRUs 431 and 433 for fast access. The generation of the lists and the sorting of each list are done by the PRU that is dedicated to the reverse path and to host processing (PRU0 431). The binary search in the sorted list is performed by the forward path PRU (PRU1 433). Table 1 shows a FMM activation list definition according to an embodiment of the invention:

TABLE 1

| | Structure of FMM | |
|---|---|---|
| Number | activation list | Definition |
| 1 | .u32 logical_start_address | Logical start address |
| | | as seen by the master |
| 2 | .u8 fmm_index_n_flags | (Shift Index (4 bits) |
| | | of FMMUs direction; |
| | | Read; Write; Bitwise) |
| | | as seen by master in |
| | | ESC register. |
| | | Additional bits |
| | | indicating operation |
| | | like read and write |
| 3 | .u8 scrtch_index | Index of FMMU |
| | | parameters stored in |
| | | register bank (scratch |
| | | memory) |
| 4 | .u16 length | Length of memory |
| | | defined by FMMU in |
| | | bytes |
| 5 | .u16 physical_start_address | Start address of local |
| | | memory |
| 6 | .u8 physical_start_mask | All these entries |
| 7 | .u8 physical_end_mask | simplify PRU code to |
| 8 | .u8 lsb_or_next_fmm_index | perform bitwise memory |
| 9 | .u8 bitiwise_shift_count | access on the-fly |
| 10 | .u8 physical_start_bit | |
| 11 | .u8 logical_start_mask_len | |
| 12 | .u8 logical_start_mask | |
| 13 | .u8 logical_end_mask | |
| 14 | .u16 length_in_bits | |
| 15 | .en | |

In Table 1, the term FMMU refers to the FMM configuration information/data that corresponds to an FMMU of a conventional slave as described in the introductory portion. Only the entries 1 to 4 in the above structure are used for the generation of the activation list, the bubble sort and the index search. Entries 5 to 15 of the above structure are indexed by scrtch_index (entry number 3) and used during the execution of the memory access. Entries 5 to 15 are stored in a separate register bank.

Both, FMM and SM information indicate specific parameters of accessing the local memory. For example, the information on bit shifts for bit-wise access to the local memory is FMM information as indicated in the above table.

Table 2 below shows the SM activation list definition according to an embodiment of the invention:

TABLE 2

| | Structure of SM | |
|---|---|---|
| Number | activation list | Definition |
| 1 | .u16 physical_start_address | Start address of local |
| | | memory |
| 2 | .u8 sm_index | Index into ESC |
| | | register space for SM |
| 3 | .u16 physical_end_address | End address of local |
| | | memory |
| 4 | .u8 buffer_ptr_scrtch_index | Helper index in buffer |
| | | mode |
| 5 | .u8 flags | (Buffer or Mailbox; |
| | | write or read) Buffer |
| | | mode has two shadow |
| | | buffers, mailbox is |
| | | single buffer, flags |
| | | for read or write |
| | | operation |
| 6 | .end | |

The procedure of generating the activation lists comprises the following steps:

Generate an intermediate FMM activation list for read or write operations. In a subsequent step the intermediate FMM activation list is sorted in the ascending order of logical address in order to obtain a final FMM activation list. A bubble sort algorithm can be used for sorting the list.

Generate the intermediate SM activation list. There is also only one list for read and write operations.

Sort the intermediate SM activation list. The entries in the intermediate SM activation list are sorted in the ascending order of physical addresses. This sorting step may also be performed according to a bubble sort algorithm.

Store the final FMM activation list and the SM activation list in the shared register bank SCRTCH 437. During the operational state of the EtherCat slave, the forward parser PRU1 433 detects a logical command and loads the FMM activation list into the register from the shared register bank SCRTCH 437. PRU1 433 then performs a binary search in the FMM activation list which is sorted by logical address and has additional configuration information of the access type and the index into the parameters for the currently active FMM settings. The current FMM settings provide the physical address which is used as the search index for SM activation list. The SM activation list contains all relevant information to access memory.

PRU1 433 determines the current FMM shared register bank (SCRTCH 437) index in the sorted FMM activation list. In the following step, PRU1 433 determines the current SYNC management shared register bank index in the SM activation list. A memory operation is performed according to the SM settings in the SM activation list.

If either the FMM settings or SM settings (FMM/SM configuration) are changed by the EtherCAT master during operation, which can occur at any time, the FMM and/or SM activation list generation and sorting is performed again. If the list generation and list sorting is not completed before the next EtherCAT frame arrives, PRU1 433 will not update the working counter WKC indicating thereby PRU1 433 is not yet ready to accept the data at this point in time.

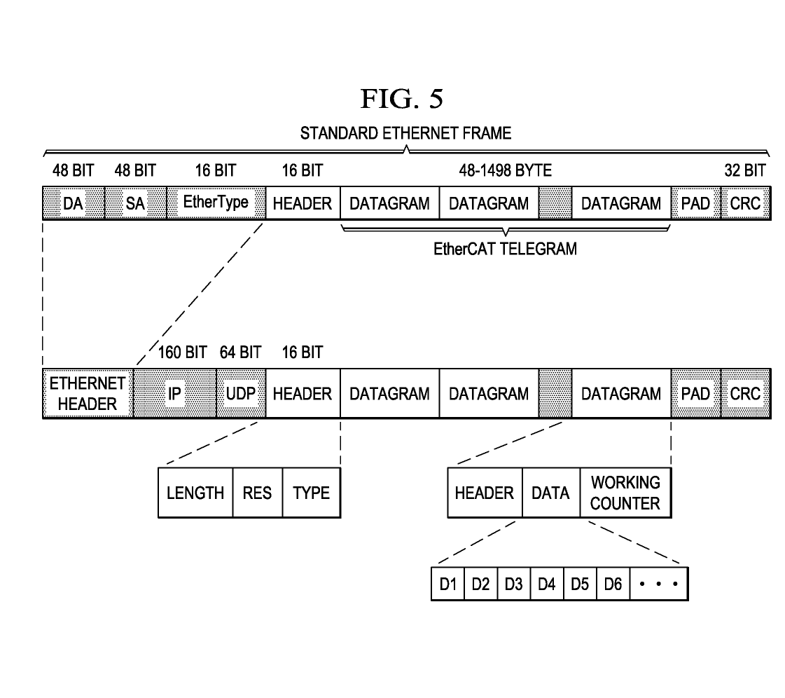

FIG. 5 shows a standard Ethernet frame 501. For EtherCAT applications, EtherCAT telegram 502 is encapsulated in the Ethernet frame and includes one or more EtherCAT datagrams destined to the EtherCAT slaves. The EtherCAT datagram 510 consist of a header 511, data 512 and working counter 513. Header 511 and data 512 are used to specify the operation that the slave must perform, and working counter 513 is updated by the slave to inform the EtherCAT master device that a slave has processed the command.

Each EtherCAT slave device 106 processes EtherCAT packets “on-the-fly” in that it receives frame 501, parses it and takes action if the address specified in an EtherCAT datagram 510 matches its own address, and forwards the entire datagram from its second port while also updating the contents and the CRC of the packet.

Through the datagrams, the EtherCAT master addresses the entire address space of up to 4 GB in which up to 65536 EtherCAT slaves, each with 65536 addresses can be located. EtherCAT datagrams 510 do not have any restrictions to the order in which the slaves are addressed with respect to the actual position of slaves (nodes) in the network. There are different addressing schemes, which are referred to as physical addressing, logical addressing, multiple addressing and broadcast addressing.

The present invention relates to logical addressing. In order to handle logical addressing, each slave has a fieldbus memory management capability. This fieldbus memory management capability enables the EtherCAT protocol to treat various slave devices as part of a 4 GB large memory space with slave space mapped in it.

The EtherCAT master 101 assembles a complete process image during the initialization phase and then makes even bit-level accesses to slave device via a single EtherCAT command. This capability makes it possible to communicate practically with any number of input/output (I/O) channels across large and small devices spanning the entire fieldbus network via a standard Ethernet controller and standard Ethernet cable.

Each datagram includes data, which is further illustrated as a series of data bytes D1 521, D2 522, D3 623, D4 524, D5 525, D6 526 . . . ) The field management capability of the PRU serves to convert a logical address into a physical address (also referred to as local address) using an activation list.

FIG. 6 shows a simplified diagram illustrating an activation list for fieldbus memory management (FMM activation list) according to an embodiment of the invention. In the order of the bytes D1 521 to D6 526 of the incoming data, each byte D1 521 to D6 526 is assigned to a specific identifier that relates to the configuration that was previously performed by a hard-wired field management unit. However, according to the present invention, the field management unit is not implemented in hardware. Accordingly, data bytes D1 521 and D2 522 are assigned to fieldbus memory management identifier (FMMI3) for a read operation. Data bytes D3 523 and D4 524 are assigned to FMM identifier I1 for read and also for a write operation. Data byte D5 525 is not assigned to any FMM identifier, while data byte D6 526 is assigned to FMM identifiers I5 for read and I4 for write operation.

Data D2 522 is also assigned to identifier I2 for a write operation. The activation list is a sorted list that indicates the corresponding fieldbus memory management information I0 to I5 for each incoming byte in a consecutive list of bytes. This is shown in the lower part of FIG. 6 in a simplified form. The activation list shows that identifiers I3 for read and I0 for write are assigned to byte number 1 (D1 521), D2 522 is assigned to I3 and I2, D3 523 and D4 524 are assigned to I1 and I1, D5 525 is assigned to I0 and I0 and D6 526 is assigned to I5 and I4. The identifier I0 indicates that no fieldbus memory management operation is required. The FMM identifiers may be pointers indicating a memory location (for example in a register) where FMM configuration data is stored. This FMM configuration data can be organized in sections each of which relates to the configuration of a conventional FMMU.

Although the invention has been described hereinabove with reference to specific embodiments, it is not limited to these embodiments and no doubt further alternatives will occur to the skilled person that lie within the scope of the invention as claimed.

What is claimed is:

1. A slave configured to be coupled to an Ethernet for Control Automation Technology (EtherCAT) bus comprising:
a configurable memory storing a first activation list indicating for consecutive bytes of data of an EtherCAT datagram a corresponding fieldbus memory management information or synchronization management information.

2. The slave according to claim 1, wherein:
the fieldbus memory management information comprises an indicator of a fieldbus memory management configuration which is assigned to a byte of data.

3. The slave according to claim 1, wherein:
the fieldbus memory management information indicates the corresponding physical address for a logical address of the fieldbus system.

4. The slave according to claim 3, wherein:
the first activation list indicates for consecutive bytes of data of an EtherCAT datagram the corresponding fieldbus memory management information: and
further comprising a second configurable memory storing a second activation list indicating for each physical address corresponding synchronization management information.

5. The slave according to claim 4, wherein:
the synchronization management information is a read access permission to a portion of a local shared memory.

6. The slave according to claim 4, wherein:
the synchronization management information is a read write access permission to a portion of a local shared memory.

7. The slave according to claim 4, wherein:
the synchronization management information is a read access refusal to a portion of a local shared memory.

8. The slave according to claim 4, wherein:
the synchronization management information is a read write access refusal to a portion of a local shared memory.

9. A fieldbus system comprising:
an Ethernet for Control Automation Technology (EtherCAT) bus;
a master coupled to said EtherCat bus;
a slave coupled to said EtherCat bus, said slave including a configurable memory storing a first activation list indicating for consecutive bytes of data of an EtherCAT datagram a corresponding fieldbus memory management information or synchronization management information.

10. The fieldbus system according to claim 9, wherein:
said fieldbus memory management information of said slave comprises an indicator of a fieldbus memory management configuration which is assigned to a byte of data.

11. The fieldbus system according to claim 9, wherein:
said fieldbus memory management information of said slave indicates the corresponding physical address for a logical address of the fieldbus system.

12. The fieldbus system according to claim 11, wherein:
said first activation list of said slave indicates for consecutive bytes of data of an EtherCAT datagram the corresponding fieldbus memory management information: and
said slave further comprising a second configurable memory storing a second activation list indicating for each physical address corresponding synchronization management information.

13. The fieldbus system according to claim 12, wherein:
said synchronization management information of said slave is a read access permission to a portion of a local shared memory.

14. The fieldbus system according to claim 12, wherein:
the synchronization management information of said slave is a read write access permission to a portion of a local shared memory.

15. The fieldbus system according to claim 12, wherein:
the synchronization management information of said slave is a read access refusal to a portion of a local shared memory.

16. The fieldbus system according to claim 12, wherein:
the synchronization management information of said slave is a read write access refusal to a portion of a local shared memory.

17. A method of operating a fieldbus system comprising a master and a slave being coupled through an Ethernet for Control Automation Technology (EtherCAT) bus, the method comprising:
configuring a first portion of a configurable memory of the slave so as to store a first activation list indicating for consecutive bytes of data of an EtherCAT datagram a corresponding fieldbus memory management information or synchronization management information.

18. The method according to claim 17, wherein:
the first activation list indicates for consecutive bytes of data of an EtherCAT datagram the corresponding fieldbus memory management information; and
the method further comprising configuring a second portion of the configurable memory of the slave to store a second activation list indicating for the fieldbus management information retrieved from the first activation list a synchronization management information.
